(19) United States
(12) Patent Application Publication
(10) Pub. No.: US 2009/0066861 A1
(43) Pub. Date: Mar. 12, 2009

(54) Display and Method of Manufacturing the Same

(76) Inventors: Soo Guy Rho, Suwon-si (KR); Hyung Guel Kim, Yongin-Si (KR); Kee Han Uh, Yongin-Si (KR); Jun Hee Moon, Yongin-Si (KR); Seong Jun Lee, Seoul (KR); Myung Woo Lee, Seoul (KR); Dae Seung Yun, Suwon-Si (KR); Jin Yup Kim, Asan-Si (KR)

Correspondence Address: MACPHERSON KWOK CHEN & HEID LLP, 2033 GATEWAY PLACE, SUITE 400, SAN JOSE, CA, 95110, US

(21) Appl. No.: 12/196,933

(22) Filed: Aug. 22, 2008

(30) Foreign Application Priority Data
Sep. 10, 2007 (KR) 10-2007-0091655

(51) Int. Cl. G02F 1/1343; G02F 1/13

(52) U.S. Cl. 349/12; 349/155; 349/187

(57) ABSTRACT

A display with a built-in touch panel and a method of manufacturing the same are provided. The display includes: a first substrate and a second substrate, wherein the first substrate and the second substrate are disposed to face each other. A conductive spacer having a first end is positioned on the first or second substrate. A cell gap spacer is disposed between the first and second substrates and at least one subsidiary cell gap spacer having a first end is disposed on the first or second substrate and positioned adjacent to the cell gap spacer. The cell gap spacer is also disposed close to the conductive spacer, and the subsidiary cell gap spacer is disposed adjacent to the cell gap spacer. Additionally, a cell gap spacer is disposed in every unit pixel, and a subsidiary cell gap spacer is disposed adjacent to each cell gap spacer.

### RELATED APPLICATION

This application claims priority to Korean Patent application No. 10-2007-0091655, filed in the Korean Intellectual Property Office on Sep. 10, 2007 and all the benefits accruing therefrom under 35 U.S.C. 119, the contents of which are herein incorporated by reference in their entirety.

### BACKGROUND OF THE INVENTION

1. Field of the Invention

The present invention relates to a display and a method of manufacturing the same, and more particularly, to a display capable of enhancing the touch sensitivity and mechanical reliability of the display with a built-in touch panel, and a method of manufacturing the display.

2. Description of the Related Art

In general, a touch panel is a device for detecting a position of an object or a finger when the object or finger is touched on a character or point of a screen of a display without using a keyboard, thereby performing a specific process. Since a conventional touch panel is manufactured separately from a display and then bonded thereto, the thickness of the display increases. Therefore, in order not to increase the thickness of a display, a display with a built-in touch panel has been suggested so that touch panel function is included during the manufacturing of the display.

In a display with a built-in touch panel, conductive pads are formed on a lower substrate having thin film transistors, pixel electrodes and the like formed thereon, and conductive spacers are formed on an upper substrate having color filters, a common electrode and the like formed thereon. The conductive spacer and the conductive pad are brought into contact with each other by pressure, and a change of resistance is detected to determine a contact position. For example, in a display with a built-in touch panel, a conductive spacer is disposed in every unit pixel, and a cell gap spacer for maintaining a gap between lower and upper substrates are disposed between conductive spacers. The unit pixel includes red, green and blue sub-pixels. Touch sensitivity of a display with the built-in touch panel can be maximized by lowering the distribution density of the cell gap spacers or reducing the thickness of the upper substrate. If the distribution density of the cell gap spacers is lowered, the compressive deformation of the cell gap spacer can be increased when the touch panel is touched. Likewise, if the thickness of the upper substrate is reduced, touch pressure can be locally applied. Accordingly, touch sensitivity can be maximized.

In order to measure the mechanical reliability of the display with a built-in touch panel, a sliding test is performed. The sliding test is performed by reciprocating a tip with a diameter of 1 mm more than 100,000 times in a predetermined direction while the display with a built-in touch panel is compressed at a pressure of 250 gf (grams-force). Since the tip moves horizontally while compressing vertically, the cell gap spacer is subjected to a vertical and a horizontal pressure simultaneously during the sliding test. If the upper substrate is thin, the horizontal compressive force is applied while the upper substrate is deformed by the vertical compressive force, so that a friction is induced between the substrate, the cell gap spacer and a lower structure. In particular, when the cell gap spacers have a small thickness and a low density, a damage caused by the sliding tip is increased, and therefore, a cell gap is not maintained. Therefore, a stain appears on a screen of the conventional display with a built-in touch panel and a sensor operation failure occurs.

### SUMMARY OF THE INVENTION

An aspect of the present invention provides a display with a built-in touch panel capable of enhancing touch sensitivity and mechanical reliability, and a method of manufacturing the same.

Another aspect of the present invention provides a display with a built-in touch panel which can improve touch sensitivity by adjusting the distribution density of cell gap spacers and enhance mechanical reliability by forming sub-cell gap spacers adjacent to the cell gap spacers, and a method of manufacturing the same.

According to an aspect of the present invention, there is provided a display including: a first substrate and a second substrate, wherein the first substrate and the second substrate are disposed to face each other; a conductive spacer having a first end positioned on the first or second substrate; a cell gap spacer disposed between the first and second substrates; and at least one subsidiary cell gap spacer disposed on the first or second substrate and positioned adjacent to the cell gap spacer.

The cell gap spacer may be positioned between a color filter of the second substrate and a thin film transistor of the first substrate.

The subsidiary cell gap spacer may have a larger sectional area and a shorter length than the cell gap spacer.

A second end of the conductive spacer is spaced apart from the first or second substrate opposite to the first end by a first gap, wherein the first gap is larger than or equal to a second gap formed between a second end of the subsidiary cell gap spacer and the first or second substrate opposite the first end of the subsidiary cell gap spacer.

The at least one subsidiary cell gap spacer may be positioned between a black matrix of the second substrate and the first substrate.

The conductive spacer may have a larger sectional area and a shorter length than the subsidiary cell gap spacer.

The conductive spacer may be spaced apart from the subsidiary cell gap spacer between a black matrix of the second substrate and the first substrate.

The cell gap spacer may have a smaller sectional area and a longer length than the conductive spacer.

According to another aspect of the present invention, there is provided a display including: a first substrate and a second substrate, wherein the first substrate and the second substrate are disposed to face each other; a conductive spacer having a first end positioned on the first or second substrate; a cell gap spacer disposed between the first and second substrates; at least one subsidiary cell gap spacer having a first end disposed on the first or second substrate and positioned adjacent to the cell gap spacer; a conductive pad corresponding to the conductive spacer; a first sensing line connected to the conductive pad and formed in a first direction; and a second sensing line connected to the conductive pad and formed in a second direction intersecting the first direction of the first sensing line.

The cell gap spacer may be positioned between a color filter of the second substrate and a thin film transistor of the first substrate.

The subsidiary cell gap spacer may have a larger sectional area and a shorter length than the cell gap spacer.

A second end of the conductive spacer is spaced apart from the first or second substrate opposite to the first end by a first gap, wherein the first gap is larger than or equal to a second gap formed between a second end of the subsidiary cell gap spacer and the first or second substrate opposite the first end of the subsidiary cell gap spacer.

The at least one subsidiary cell gap spacer may be positioned between a black matrix of the second substrate and the first substrate.

The conductive spacer may have a larger sectional area and a shorter length than the at least one subsidiary cell gap spacer.

The conductive spacer may be spaced apart from the subsidiary cell gap spacer between a black matrix of the second substrate and the first substrate.

The cell gap spacer may have a smaller sectional area and a longer length than the conductive spacer.

According to a further aspect of the present invention, there is provided a method of manufacturing a display including: forming a first substrate including gate lines, data lines, pixel electrodes, thin film transistors and a conductive pad; forming a second substrate including a black matrix, color filters, a conductive spacer, a common electrode, a cell gap spacer and a subsidiary cell gap spacer; and positioning the first substrate and the second substrate in a spaced apart relationship with a liquid crystal material interposed between the upper and first substrates.

Forming the first substrate may include forming in a first direction the gate lines and a first sensing line spaced apart therefrom on a substrate; forming in a second, different direction the data lines intersecting the gate lines and a second sensing line spaced apart therefrom; forming a protective layer on top of the substrate and then etching predetermined regions of the protective layer to form a plurality of contact holes; and forming on the protective layer the pixel electrodes in regions at which the gate and data lines intersect each other, and forming the conductive pad connected to the first and second sensing lines through the plurality of contact holes.

Forming the second substrate may include selectively forming the black matrix on a substrate; forming an insulating layer on the substrate and then patterning the insulating layer to form a protrusion on the black matrix; forming the color filters on the substrate except the black matrix; forming a conductive layer on top of the substrate and then patterning the conductive layer to form the common electrode, and forming a conductive layer on the protrusion to form the conductive spacer; and forming the cell gap spacer and at least one subsidiary cell gap spacer every unit pixel on the substrate.

The cell gap spacer may be formed on the color filter, and the subsidiary cell gap spacer may be formed on the black matrix.

### BRIEF DESCRIPTION OF THE DRAWINGS

Preferred embodiments of the present invention can be understood in more detail from the following description taken in conjunction with the accompanying drawings, in which:

FIG. 1 is a plan view of a display according to a first exemplary embodiment of the present invention;

FIG. 2 is an enlarged plan view of portion A in FIG. 1;

FIG. 3 is a sectional view taken along line I-I′ in FIG. 2;

FIG. 4 is a sectional view taken along line II-II′ in FIG. 2;

FIG. 5 is a plan view of a display according to a second exemplary embodiment of the present invention;

FIG. 6 is an enlarged plan view of portion B in FIG. 5;

FIG. 7 is a sectional view taken along line III-III′ in FIG. 6;

FIG. 8 is a sectional view taken along line IV-IV′ in FIG. 6;

FIGS. 9A to 13A and FIGS. 9B to 13B are sectional views sequentially illustrating a method of fabricating a lower substrate of the display according to the second exemplary embodiment of the present invention; and

FIGS. 14A to 18A and FIGS. 14B to 18B are sectional views sequentially illustrating a method of fabricating a lower substrate of the display according to a third exemplary embodiment of the present invention.

### DETAILED DESCRIPTION OF THE INVENTION

Hereinafter, exemplary embodiments of the present invention are described in detail with reference to the accompanying drawings. However, the present invention is not limited to the embodiments disclosed below but may be implemented in different forms. These embodiments are provided only for illustrative purposes and for full understanding of the scope of the present invention by those skilled in the art.

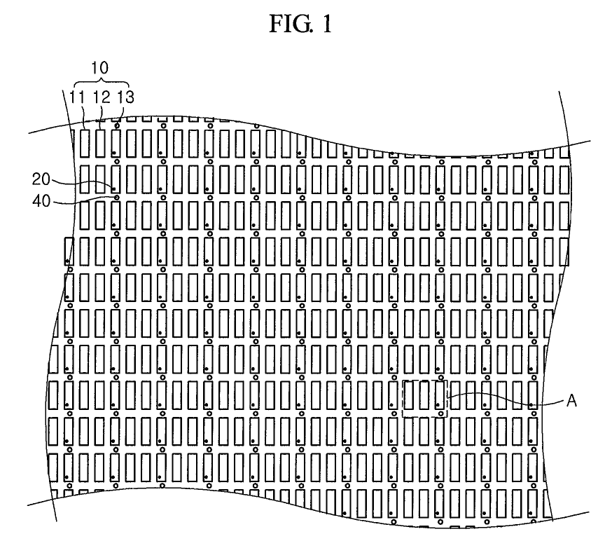

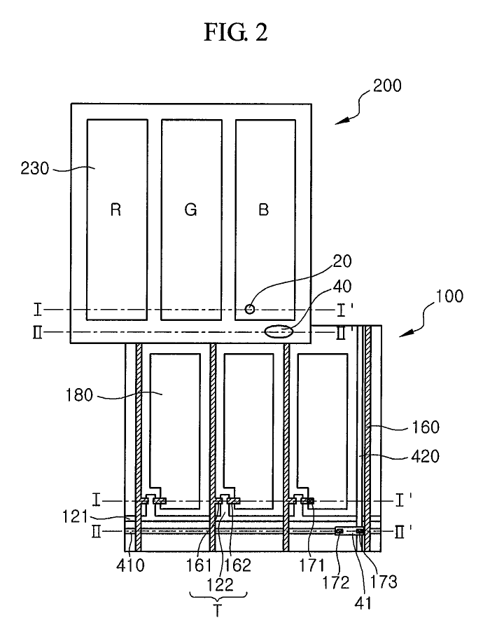

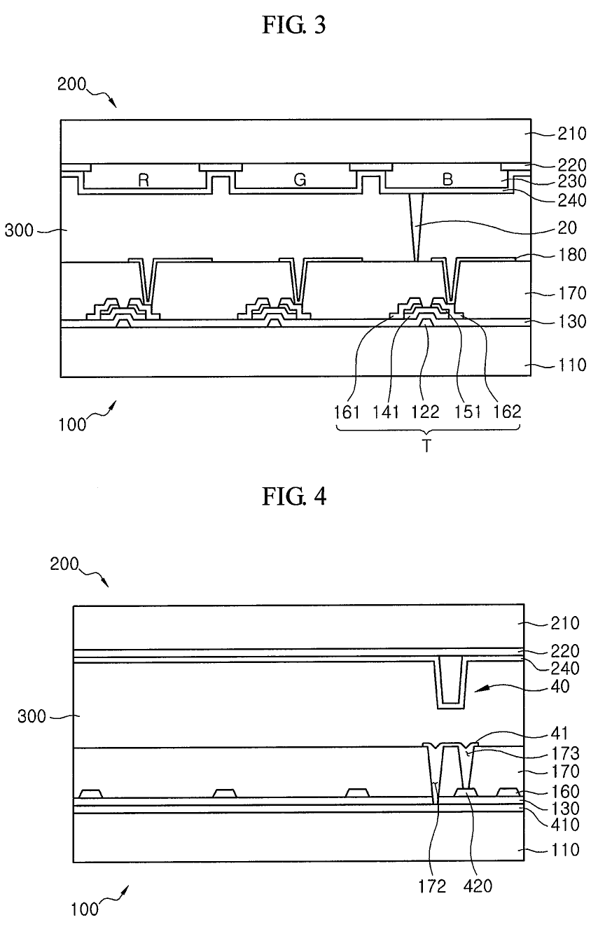

FIG. 1 is a plan view of a display with a built-in touch panel according to a first embodiment of the present invention, and FIG. 2 is an enlarged plan view of portion A in FIG. 1. Also, FIG. 3 is a sectional view taken along line I-I′ in FIG. 2, and FIG. 4 is a sectional view taken along line II-II′ in FIG. 2.

Referring to FIGS. 1 to 4, the display with a built-in touch panel according to the exemplary embodiment of the present invention includes: lower and upper substrates 100 and 200 disposed facing to each other; and a liquid crystal layer 300 interposed between the lower and upper substrates 100 and 200. The display with a built-in touch pad further includes: a cell gap spacer 20 which is disposed in every unit pixel 10 to maintain a gap between the lower and upper substrates 100 and 200; conductive spacers 40 formed in the upper substrate 200; and conductive pads 41 formed in the lower substrate 100.

In this exemplary embodiment, the unit pixel 10 includes, for example, three sub-pixels, preferably red, green and blue sub-pixels 11, 12 and 13, respectively. For example, the red, green and blue sub-pixels 11, 12 and 13 are alternately arranged in an abscissa direction (horizontal), and the same sub-pixels are arranged in an ordinate direction (vertical). However, the red, green and blue sub-pixels 11, 12 and 13 may also be alternately arranged in the ordinate direction.

The lower substrate 100 includes: a plurality of gate lines 121 extending in one direction over a first insulating substrate 110; a plurality of data lines 160 extending in another direction intersecting the gate lines 121; pixel electrodes 180 formed in sub-pixel regions defined by the gate and data lines 121 and 160; and thin film transistors T connected to the gate lines 121, the data lines 160 and the pixel electrodes 180 and including active layers 141 and ohmic contact layers 151. The lower substrate 100 further includes: first sensing lines 410 spaced apart from the gate lines 121 and extending in one direction; second sensing lines 420 spaced apart from the data lines 160 and extending in another direction; and conductive pads 41 formed at intersections of the first and second sensing lines 410 and 420.

The upper substrate 200 includes: a black matrix 220 formed between sub-pixels on top of a second insulating substrate 210; color filters 230 formed on regions of the second insulating substrate 210 where the black matrix 220 is not formed; and a common electrode 240 formed on an entire surface of the black matrix 220 and the color filters 230. The cell gap spacers 20 and the conductive spacers 40 may be formed on top of the upper substrate 200.

Each of the cell gap spacers 20 is disposed in a unit pixel 10. For example, the cell gap spacer 20 may be formed on the color filter 230 of the blue sub-pixel 13. The cell gap spacer 20 may be formed between the color filter 230 and the thin film transistor T. The conductive spacers 40 are disposed adjacent to the cell gap spacers 20. For example, the conductive spacer 40 may be formed on the black matrix 220 between the blue sub-pixels 13 of adjacent unit pixels 10. However, the arrangement of the cell gap spacers 20 and the conductive spacers 40 may vary. Here, the cell gap spacer 20 is formed to be longer than the conductive spacer 40 to be in contact with the lower and upper substrates 100 and 200, while the conductive spacer 40 is formed to be spaced apart from the conductive pad 41 at a predetermined interval. In addition, the conductive spacer 40 has a sectional area larger than the cell gap spacer 20.

As described above, the cell gap spacer 20 and the conductive spacer 40 are arranged in each unit pixel 10 such that they are adjacent to each other. Accordingly, a compressive force, which was applied only to the cell gap spacer 20 in the related art, can be distributed to the cell gap spacer 20 and the conductive spacer 40, so that breakdown of the cell gap spacer 20 can be prevented.

However, even if the cell gap spacer 20 and the conductive spacer 40 are arranged adjacent to each other in each unit pixel 10 to distribute the compressive force according to the exemplary embodiment of the present invention, the cell gap spacer 20 and the conductive spacer 40 may not be able to distribute all the compressive force when the compressive force is large. Thus, a second exemplary embodiment of the present invention for better distributing the compressive force is described below.

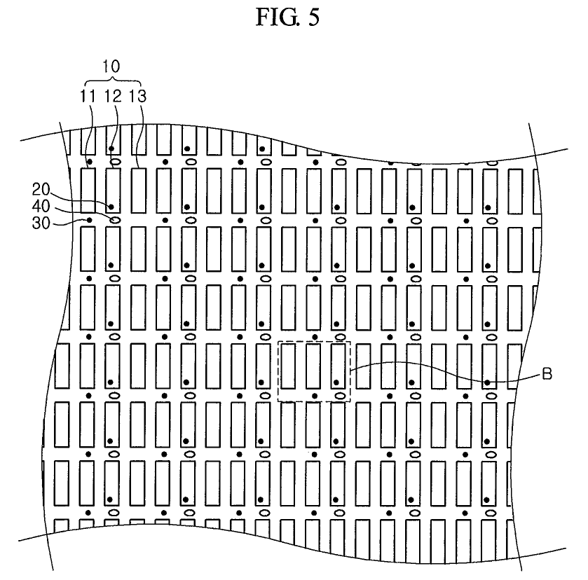

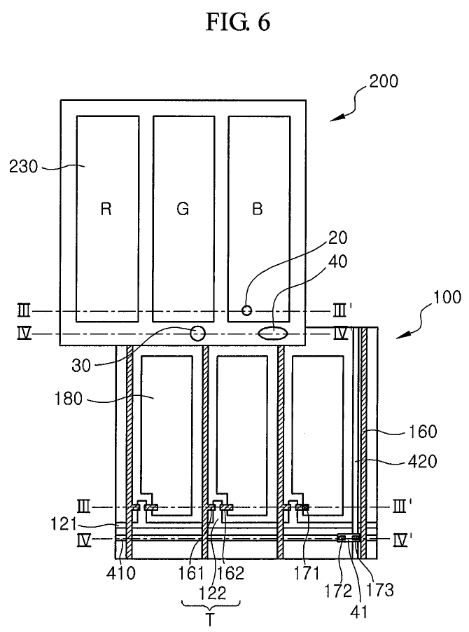

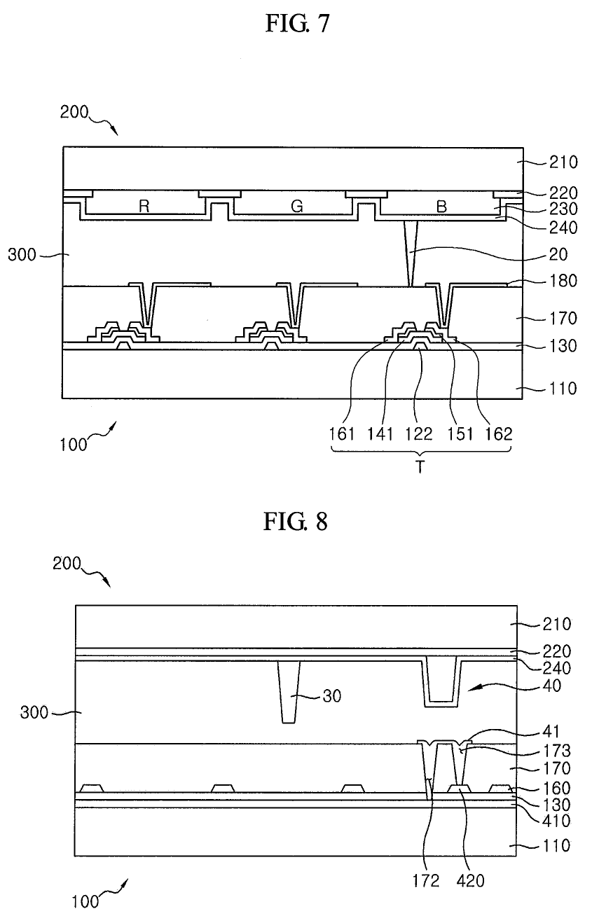

FIG. 5 is a plan view of a display with a built-in display panel according to a second exemplary embodiment of the present invention, and FIG. 6 is an enlarged plan view of portion B in FIG. 5. FIG. 7 is a sectional view taken along line III-III′ in FIG. 6, and FIG. 8 is a sectional view taken along line IV-IV′ in FIG. 6.

Referring to FIGS. 5 to 8, the display with a built-in touch panel according to a second exemplary embodiment of the present invention includes: lower and upper substrates 100 and 200 disposed to face each other; and a liquid crystal layer 300 interposed between the lower and upper substrates 100 and 200. The display with a built-in touch panel further includes: cell gap spacers 20 disposed in the respective unit pixels 10 and formed on color filters 220; at least one subsidiary cell gap spacer 30 disposed near each of the cell gap spacers 20; and conductive spacers 40 disposed in the respective unit pixels 10. The unit pixel 10 may include three sub-pixels, i.e., red, green and blue sub-pixels 11, 12 and 13.

The lower substrate 100 includes: a plurality of gate lines 121 extending in one direction over a first insulating substrate 110; a plurality of data lines 160 extending to intersect the gate lines 121; pixel electrodes 180 formed in sub-pixel regions defined by the gate and data lines 121 and 160; and thin film transistors T connected to the gate lines 121, the data lines 160 and the pixel electrodes 180. The lower substrate 100 further includes first sensing lines 410 spaced apart from the gate lines 121 and extending in one direction, second sensing lines 420 spaced apart from the data lines 160 and extending in another direction, and conductive pads 41 formed at intersections of the first and second sensing lines 410 and 420.

The gate lines 121 are formed to extend, for example, in an abscissa direction, wherein a portion of the gate line 121 protrudes to form a gate electrode 122. A gate insulating layer 130 is formed on an entire surface of the lower substrate 100 having the gate lines 121 formed thereon. The gate insulating layer 130 may be formed into a single- or multiple-layered structure using SiO₂, SiNₓ or the like. Meanwhile, an active layer 141 made of a semiconductor such as amorphous silicon is formed on the gate insulating layer 130, and the insulating layer 130 is formed on the gate electrode 122. An ohmic contact layer 151 made of a semiconductor such as n+ hydrogenated amorphous silicon highly doped with silicide or a n-type impurity is formed on the active layer 141. The ohmic contact layer 151 may be removed in channel portions between source and drain electrodes 161 and 162.

The data lines 160 are formed on the gate insulating layer 130. The data lines 160 are formed to extend in a direction intersecting the gate lines 121, i.e., an ordinate direction. Regions at which the data lines 160 intersect the gate lines 121 are defined as sub-pixel regions. The data line 160 is extended and protruded up to a top surface of the ohmic contact layer 151 to form the source electrode 161. The drain electrode 162 is formed on the ohmic contact layer 151 to be spaced apart from the source electrode 161.

A protective layer 170 is formed on the entire surface of the lower substrate 100 having the gate and data lines 121 and 160 formed thereon. The protective layer 170 may include an inorganic or organic insulating layer. In addition, first, second and third contact holes 171, 172 and 173 are formed at predetermined regions of the protective layer 170, wherein the first contact hole 171 exposes a predetermined region of the drain electrode 162, the second contact hole 172 exposes a portion of the first sensing line 410, and the third contact hole 173 exposes a portion of the second sensing line 420.

The pixel electrodes 180 are formed on the protective layer 170. The pixel electrode 180 is formed of a transparent conductive material such as indium tin oxide (ITO) or indium zinc oxide (IZO). The pixel electrode 180 is connected to the drain electrode 162 through the first contact hole 171.

The first sensing line 410 is formed to be spaced apart from the gate line 121, and may be simultaneously formed with the gate line 121. The second sensing line 420 is formed to be spaced apart from the data line 160 at a predetermined interval, and the second sensing line 420 is formed in each unit pixel. For example, the second sensing line 420 may be formed between the blue and red sub-pixels 13 and 11, and in particular, may be formed at a side of the blue sub-pixel 13 to be adjacent to the data line 160. Further, the second sensing lines 420 may be simultaneously formed with the data lines 160.

The conductive pad 41 is formed at an intersection of the first and second sensing lines 410 and 420, and connected to the first and second sensing lines 410 and 420 through the second and third contact holes 172 and 173. Further, the conductive pad 41 is spaced apart from the pixel electrode 180, and may be simultaneously formed with the pixel electrode 180.

The upper substrate 200 includes a black matrix 220, color filters 230 and a common electrode 240, which are formed on a second insulating substrate 210. The upper substrate 200 further includes cell gap spacers 20, subsidiary cell gap spacers 30 and conductive spacers 40.

The black matrix 220 is formed between the sub-pixels to prevent light leakage through regions except the sub-pixels and to prevent light interference between the sub-pixels. Further, the black matrix 220 is formed of a photosensitive organic material containing a black pigment. Carbon black, titanium oxide or the like is used as the black pigment. Meanwhile, the black matrix 220 may include a metallic material such as Cr or CrOₓ.

The color filters 230 include red R, green G and blue B color filters. The red R, green G and blue B color filters are alternately and repeatedly arranged in the sub-pixels having the boundary of the black matrix 220. The color filters 230 give colors to the light which are emitted from a light source and then pass through the liquid crystal layer 300. The color filters 230 may be formed of a photosensitive organic material.

The common electrode 240 is formed on the black matrix 220 and the color filters 230 of a transparent conductive material such as indium tin oxide (ITO) or indium zinc oxide (IZO).

Meanwhile, each cell gap spacer 20 is disposed in each unit pixel 10. For example, the cell gap spacer 20 may be formed on the color filter 230 of the blue sub-pixel 13. However, the cell gap spacer 20 may be disposed on the red or green sub-pixel 11 or 12 instead of the blue sub-pixel 13. Further, the cell gap spacer 20 can be formed in a region corresponding to the thin film transistor T of the lower substrate 100.

The subsidiary cell gap spacers 30 are formed to reduce the compressive deformation of the cell gap spacers 20, and at least one of the subsidiary cell gap spacers 30 is disposed around each cell gap spacer 20. The subsidiary cell gap spacers 30 may be formed on the black matrix 220 between the sub-pixels so that an aperture ratio of the display is not degraded. When the number of the subsidiary cell gap spacers 30 is one, it is disposed adjacent to the cell gap spacer 20. For example, the subsidiary cell gap spacer 30 is formed on the black matrix 220 between the red sub-pixels 11. Alternatively, when a plurality of the subsidiary cell gap spacers 30 is disposed, the subsidiary cell gap spacers 30 may be concentrated around the cell gap spacer 20. Even in this case, the subsidiary cell gap spacers 30 are formed on the black matrix 220. Here, the cell gap spacers 20 are formed on the color filters 230 and the subsidiary cell gap spacers 30 are formed on the black matrix 220. In particular, the cell gap spacers 20 are formed to be taller than the subsidiary cell gap spacers 30 with respect to a surface of the black matrix 220, when the cell gap spacers 20 and the subsidiary cell gap spacers 30 are simultaneously formed. Hence, although the cell gap spacers 20 are in close contact with the lower and upper substrates 100 and 200, the subsidiary cell gap spacers 30 can be spaced apart from the lower substrate 100.

Each conductive spacer 40 is disposed in each unit pixel 10. For example, the conductive spacer 40 is formed on the black matrix 230 between the blue sub-pixels 13 in adjacent unit pixels 10, and disposed to be spaced apart from the cell gap spacer 20 and the subsidiary cell gap spacer 30 by a predetermined interval. Further, the conductive spacer 40 is formed in a region corresponding to the conductive pad 41 formed in the lower substrate 100.

In addition, the subsidiary cell gap spacer 30 is formed to have a larger sectional area than the cell gap spacer 20, and to be taller than the conductive spacer 40. The conductive spacer 40 is formed to have a larger sectional area than the cell gap spacer 20. Since the cell gap spacer 20 is disposed close to the conductive spacer 40 and the subsidiary cell gap spacer 30 is disposed around the cell gap spacer 20, even if a strong compressive force is applied to the cell gap spacer 20, the compressive force is distributed by the subsidiary cell gap spacer 30. Accordingly, it is possible to prevent breakdown of the cell gap spacer 20.

The subsidiary cell gap spacer 30 is formed to be taller than the conductive spacer 40, so that the subsidiary cell gap spacer 30 can primarily support the cell gap ahead of the conductive spacer 40 when a compressive force larger than a tolerable limit of the cell gap spacer 20 is applied to the cell gap spacer 20. Of course, the conductive spacer 40 can be easily brought into contact to the conductive pad 41 because the subsidiary cell gap spacer 30 and the conductive spacer 40 are spaced apart by a predetermined distance from each other, and the subsidiary cell gap spacer 30 can also be compressively deformed to a certain extent. A gap between the subsidiary cell gap spacer 30 and the lower substrate 100 may be smaller than the deformation length of the cell gap spacer subject to compressive force. Therefore, breakdown of the cell gap spacer 20 by the compressive force can be prevented. Meanwhile, although not shown, protrusions higher than other regions may be formed in the protective layer 170 of the lower substrate 100 corresponding to the subsidiary cell gap spacers 30.

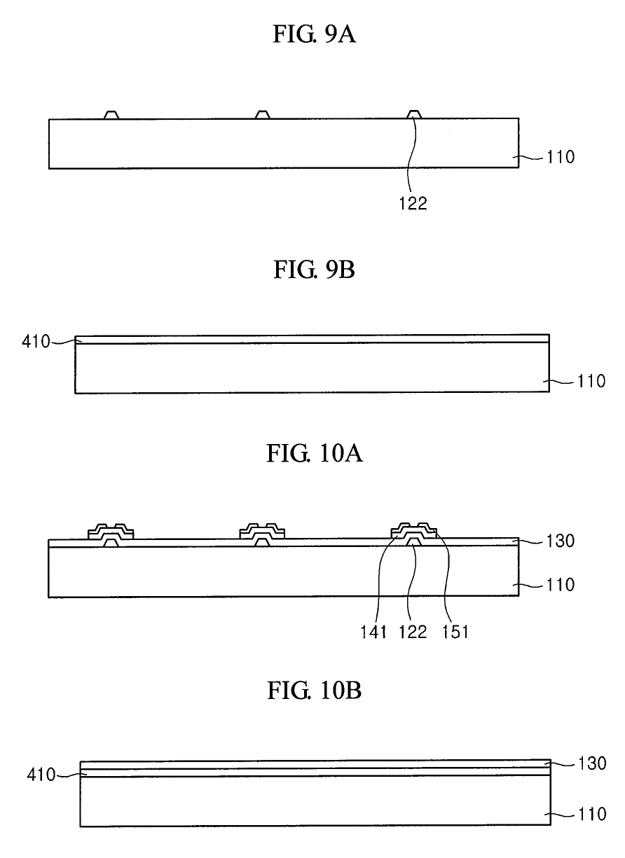

FIGS. 9A to 13A and FIGS. 9B to 13B are sectional views sequentially illustrating a method of fabricating a lower substrate of the display with a built-in touch panel according to a second embodiment of the present invention, in which FIGS. 9A to 13A are sectional views taken along line III-III′ of the lower substrate in FIG. 6 and FIGS. 9B to 13B are sectional views taken along line IV-IV′ of the lower substrate in FIG. 6.

Referring to FIGS. 9A and 9B, a first conductive layer is formed on a transparent insulating substrate 110 made of glass, quartz, ceramic, plastic or the like. Then, the first conductive layer is patterned through a photolithographic and etching process using a first mask to form a plurality of gate lines (not shown) extending in one direction at predetermined intervals, gate electrodes 122 protruding from the gate lines, and first sensing lines 410 spaced apart from the gate lines by predetermined intervals.

Referring to FIGS. 10A and 10B, a gate insulating layer 130 and first and second semiconductor layers are sequentially formed on an entire surface of the substrate 110. Then, the first and second semiconductor layers are patterned through a photolithographic and etching process using a second mask to form active and ohmic contact layers 141 and 151. The gate insulating layer 130 may be formed of an inorganic insulating material containing silicon oxide or silicon nitride. An amorphous silicon layer may be used as the first semiconductor layer, and a n+ hydrogenated amorphous silicon layer highly doped with silicide or a n-type impurity may be used as the second semiconductor layer.

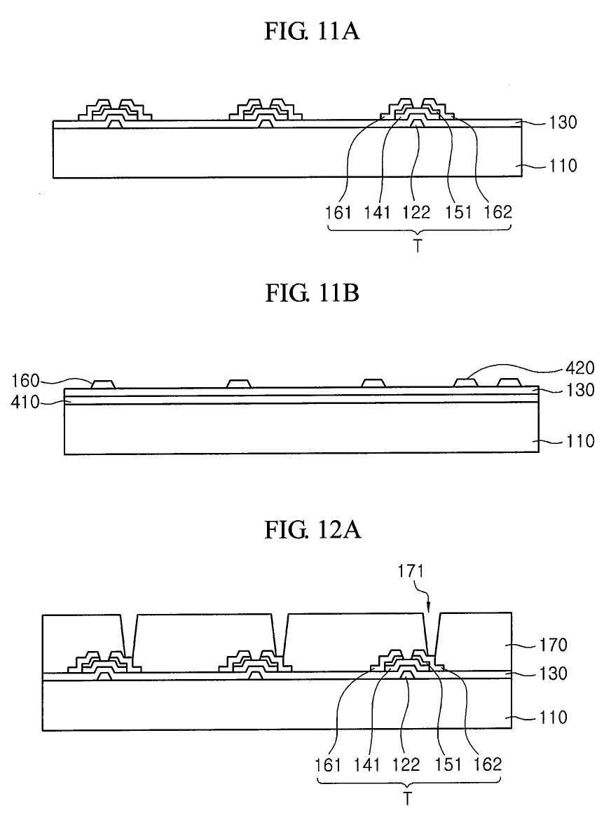

Referring to FIGS. 11A and 11B, a second conductive layer is formed on top of the entire surface of the substrate 110. Then, the second conductive layer is patterned through a photolithographic and etching process using a third mask to form source and drain electrodes 161 and 162 and a plurality of data lines 160 extending in the direction perpendicular to the gate lines (not shown). Simultaneously, second sensing lines 420 spaced apart from the data lines 160 at predetermined intervals are formed. For example, the second sensing line 420 is formed in every unit pixel including three sub-pixels.

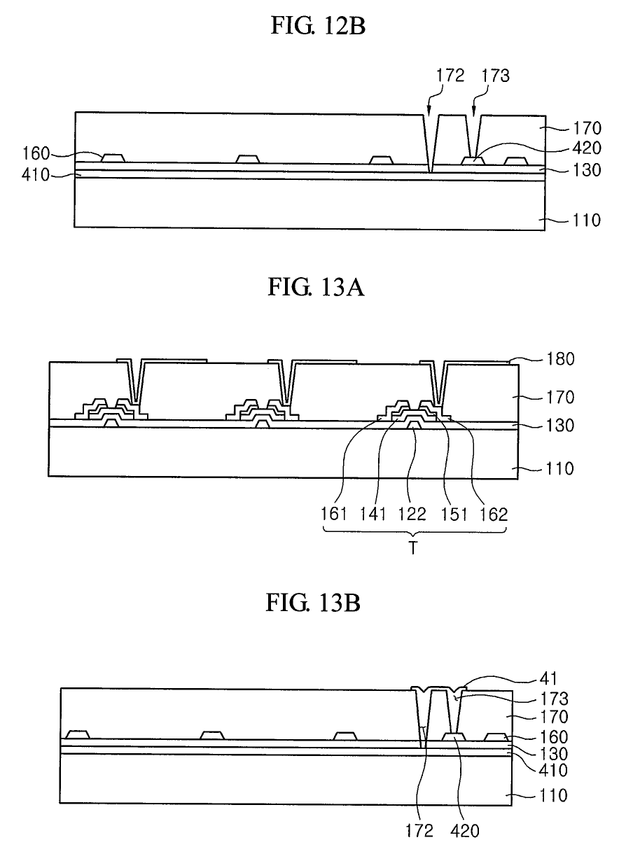

Referring to FIGS. 12A and 12B, a protective layer 170 is formed on the entire surface of the substrate 110. Then, a portion of the protective layer 170 is etched through a photolithographic and etching process using a fourth mask to form first contact holes 171 for exposing the drain electrodes 162, second contact holes 172 for exposing the first sensing lines 410 and third contact holes 173 for exposing the second sensing lines 420.

Referring to FIGS. 13A and 13B, a third conductive layer is formed on the protective layer 170. Then, the third conductive layer is patterned through a photolithographic and etching process using a fifth mask to form pixel electrodes 180 and conductive pads 41. The pixel electrodes 180 are formed in sub-pixel regions at the intersections of the gate and data lines 121 and 160. The conductive pad 41 is formed to be electrically connected to the first and second sensing lines 410 and 420 through the second and third contact holes 172 and 173. Since the conductive pads 41 are formed in regions except the sub-pixel regions, the conductive pads 41 are not electrically connected to the pixel electrodes 180. The third conductive layer may be formed of a transparent conductive layer containing ITO or IZO.

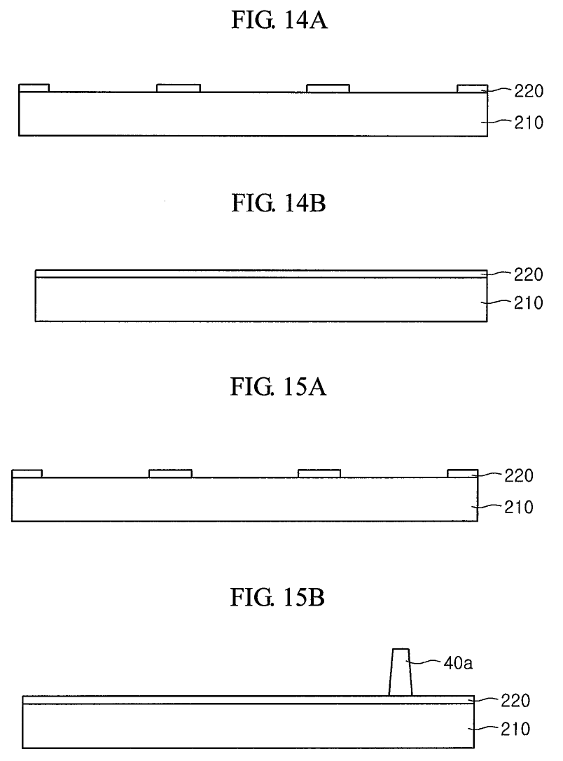

FIGS. 14A to 18A and FIGS. 14B to 18B are sectional views sequentially illustrating a method of fabricating an upper substrate of the display with a built-in touch panel according to a third embodiment of the present invention, in which FIGS. 14A to 18A are sectional views taken along line III-III′ of the upper substrate in FIG. 6, and FIGS. 14B to 18B are sectional views taken along line IV-IV′ of the upper substrate in FIG. 6.

Referring to FIGS. 14A and 14B, a black matrix 220 is formed on a transparent insulating substrate 210 made of glass, quartz, ceramic, plastic or the like. The black matrix 220 may be formed of a photosensitive organic material containing a black pigment such as carbon black or titanium oxide. Further, the black matrix 220 is formed in regions except for the sub-pixels. The black matrix 220 separates color filters from one another, and blocks light passing through liquid crystal cells in regions which are not controlled by the pixel electrodes 180 of the lower substrate 100, whereby a contrast ratio of the display is enhanced.

Referring to FIGS. 15A and 15B, protrusions 40a are selectively formed on the black matrix 220. The protrusion 40a may be formed at every unit pixel, i.e., every three sub-pixels. The protrusion 40a may be formed on the black matrix 220 between blue sub-pixels. Further, the protrusion 40a may be formed in regions corresponding to the conductive pads 41 of the lower substrate 100. The protrusions 40a are formed by coating an entire surface of the substrate 210 with an organic or inorganic insulating layer and then performing a photolithographic and etching process using a predetermined mask.

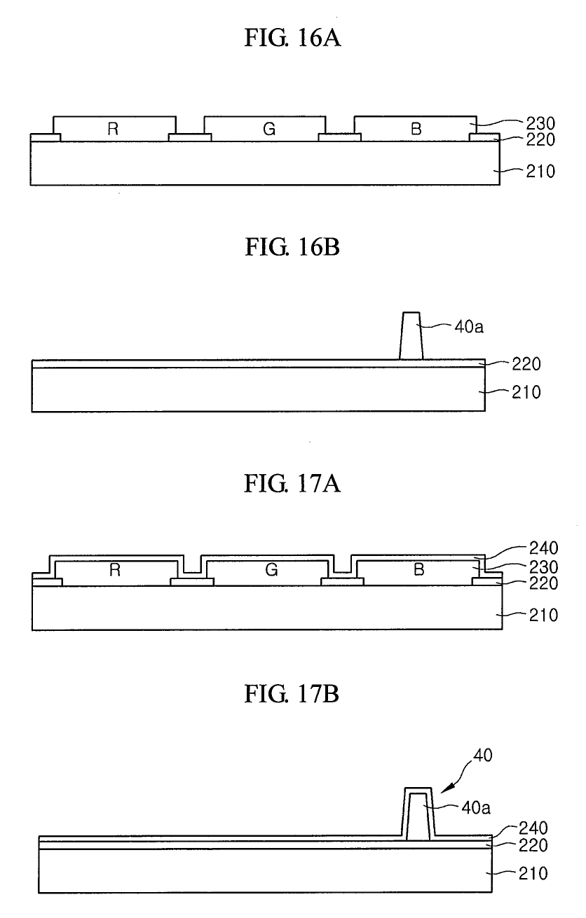

Referring to FIGS. 16A and 16B, a plurality of color filters 230, e.g., red R, green G and blue B color filters, are formed on the entire surface of the substrate 210 having the black matrix 220 and the protrusion 40a formed thereon. The process of forming the color filters 230 will be described. A negative color resist having a red pigment scattered therein is applied to the substrate 210 and then exposed using a mask for opening regions in which the red color filters will be formed. Then, by developing the negative color resist using a developing solution, the exposed regions of the negative color resist are not removed but remains as a pattern, and only the unexposed regions thereof are removed. Hence, the red color filters 230 are formed on the substrate 210. The blue and green color filters 230 may also be formed through the aforementioned process.

Referring to FIGS. 17A and 17B, a conductive layer is formed on the entire surface of the substrate 210 having the plurality of color filters 230 formed thereon. The conductive layer is formed of a transparent conductive layer containing ITO or IZO through a sputtering method or the like. Then, a common electrode 240 is formed on the entire surface of the substrate 210. Accordingly, the conductive layer is also disposed on the protrusions 40a to form conductive spacers 40. Here, an overcoat layer may be formed on the plurality of color filters 230 for the purpose of satisfactory step coverage when the common electrode 240 is formed.

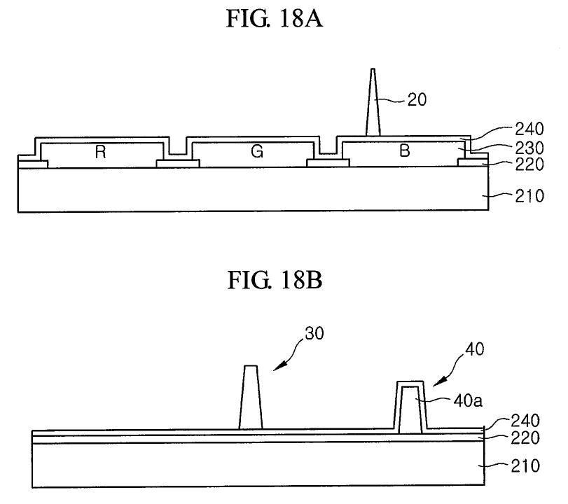

Referring to FIGS. 18A and 18B, an organic material is coated on the entire surface of the substrate 210. Then, a photolithographic and etching process using a predetermined mask is performed to form cell gap-spacers 20 and subsidiary cell gap spacers 30. The subsidiary cell gap spacer 30 is formed to have a larger sectional area than the cell gap spacer 20. At this time, the cell gap spacer 20 is formed on top of the blue color filter 230 in the blue sub-pixel adjacent to the region having the conductive spacer 40 formed therein. Further, the cell gap spacer 20 may be formed in a region corresponding to a thin film transistor. At least one subsidiary cell gap spacer 30 is formed around the cell gap spacer 20. For example, the subsidiary cell gap spacer 30 may be formed on the black matrix 220 between the red sub-pixels.

As described above, the lower and upper substrates 100 and 200 are individually fabricated, and a liquid crystal layer 300 is then interposed therebetween. The liquid crystal layer 300 is formed through a one drop filling (ODF) manner. If the liquid crystal layer 300 is formed through a vacuum injection manner, the pressure in a cell is increased due to liquid crystal injection, so that the cell gap spacers 20 may be broken down easily. By employing the ODF method, the pressure in a cell due to the liquid crystal injection can be reduced and the height of the cell gap spacer 20 can be lowered. Accordingly, the breakdown of the cell gap spacer 20 can be prevented.

Meanwhile, although the cell gap spacers 20 are formed in the upper substrate 200 in these embodiments, the cell gap spacers 20 may be formed in the lower substrate 100. In this case, the cell gap spacers 20 may be formed on the thin film transistors T of the lower substrate 100.

According to the embodiments of the present invention, a cell gap spacer is disposed close to a conductive spacer, or a subsidiary cell gap spacer is disposed around the cell gap spacer in order to distribute a compressive force concentrated on the cell gap spacer and thus enhance mechanical reliability.

Further, each of the cell gap spacers is disposed in every unit pixel, and a plurality of subsidiary cell gap spacers is disposed around the cell gap spacer. Accordingly, the distribution density of the cell gap spacers is lowered as compared with a conventional display having a built-in touch panel, whereby the touch sensitivity can be enhanced. In addition, a compressive force concentrated on the cell gap spacer is distributed, and thereby mechanical reliability is enhanced.

While the present invention has been illustrated and described in connection with the accompanying drawings and the preferred embodiments, the present invention is not limited thereto and is defined by the appended claims. Therefore, it will be understood by those skilled in the art that various modifications and changes can be made thereto without departing from the spirit and scope of the invention defined by the appended claims.

What is claimed is:

1. A display, comprising:
a first substrate and a second substrate, wherein the first and second substrates are disposed to face each other;
a conductive spacer having a first end positioned on the first or second substrate;
a cell gap spacer disposed between the first and second substrates; and
at least one subsidiary cell gap spacer having a first end disposed on the first or second substrate and positioned adjacent to the cell gap spacer.

2. The display as claimed in claim 1, wherein the cell gap spacer is positioned between a color filter of the second substrate and a thin film transistor of the first substrate.

3. The display as claimed in claim 1, wherein the subsidiary cell gap spacer has a larger sectional area and a shorter length than the cell gap spacer.

4. The display as claimed in claim 1, wherein a second end of the conductive spacer is spaced apart from the first or second substrate opposite to the first end of the conductive spacer by a first gap, and further wherein the first gap is larger than or equal to a second gap formed between a second end of the subsidiary cell gap spacer and the first or second substrate opposite the first end of the subsidiary cell gap spacer.

5. The display as claimed in claim 1, wherein the at least one subsidiary cell gap spacer is positioned between a black matrix of the second substrate and the first substrate.

6. The display as claimed in claim 1, wherein the conductive spacer has a larger sectional area and a shorter length than the at least one subsidiary cell gap spacer.

7. The display as claimed in claim 1, wherein the conductive spacer is spaced apart from the subsidiary cell gap spacer between a black matrix of the second substrate and the first substrate.

8. The display as claimed in claim 1, wherein the cell gap spacer has a smaller sectional area and a longer length than the conductive spacer.

9. A display, comprising:
a first substrate and a second substrate, wherein the first substrate and the second substrate are disposed to face each other;
a conductive spacer having a first end positioned on the first or second substrate;
a cell gap spacer disposed between the first and second substrates;
at least one subsidiary cell gap spacer having a first end disposed on the first or second substrate and positioned adjacent to the cell gap spacer;
a conductive pad corresponding to the conductive spacer;
a first sensing line connected to the conductive pad and formed in a first direction; and
a second sensing line connected to the conductive pad and formed in a second direction intersecting the first direction of the first sensing line.

10. The display as claimed in claim 9, wherein the cell gap spacer is positioned between a color filter of the second substrate and a thin film transistor of the first substrate.

11. The display as claimed in claim 9, wherein the subsidiary cell gap spacer has a larger sectional area and a shorter length than the cell gap spacer.

12. The display as claimed in claim 9, wherein a second end of the conductive spacer is spaced apart from the first or second substrate opposite to the first end of the conductive spacer by a first gap, and further wherein the first gap is larger than or equal to a second gap formed between a second end of the subsidiary cell gap spacer and the first or second substrate opposite the first end of the subsidiary cell gap spacer.

13. The display as claimed in claim 9, wherein the at least one subsidiary cell gap spacer is positioned between a black matrix of the second substrate and the first substrate.

14. The display as claimed in claim 9, wherein the conductive spacer has a larger sectional area and a shorter length than the at least one subsidiary cell gap spacer.

15. The display as claimed in claim 9, wherein the conductive spacer is spaced apart from the subsidiary cell gap spacer between a black matrix of the second substrate and the first substrate.

16. The display as claimed in claim 9, wherein the cell gap spacer has a smaller sectional area and a longer length than the conductive spacer.

17. A method of manufacturing a display, comprising:
forming a first substrate including gate lines, data lines, pixel electrodes, thin film transistors and a conductive pad;
forming a second substrate including a black matrix, color filters, a conductive spacer, a common electrode, a cell gap spacer and a subsidiary cell gap spacer; and
dropping liquid crystal on the first substrate and then bonding the first and second substrates.

18. The method as claimed in claim 17, wherein forming the first substrate comprises:
forming in a first direction the gate lines and a first sensing line spaced apart therefrom on a substrate;
forming in a second, different direction the data lines intersecting the gate lines and a second sensing line spaced apart therefrom;
forming a protective layer on top of the substrate and then etching predetermined regions of the protective layer to form a plurality of contact holes; and
forming on the protective layer the pixel electrodes in regions at which the gate and data lines intersect each other, and forming the conductive pad connected to the first and second sensing lines through the plurality of contact holes.

19. The method as claimed in claim 17, wherein forming the second substrate comprises:
selectively forming the black matrix on a substrate;
forming an insulating layer on the substrate and then patterning the insulating layer to form a protrusion on the black matrix;
forming the color filters on the substrate except the black matrix;
forming a conductive layer on top of the substrate and then patterning the conductive layer to form the common electrode, and forming the conductive spacer using the protrusion having the conductive layer formed thereon; and
forming the cell gap spacer and at least one subsidiary cell gap spacer in every unit pixel on the substrate.

20. The method as claimed in claim 17, wherein the cell gap spacer is formed on the color filter, and the subsidiary cell gap spacer is formed on the black matrix.
